(19) United States
(12) Patent Application Publication
(10) Pub. No.: US 2023/0148593 A1
(43) Pub. Date: May 18, 2023

(54) COMPOSITE MEMBRANE COMPRISING A FLUORINATED POLYMER OR SILICONE SURFACE LAYER CONTAINING SILVER, METHOD FOR THE PRODUCTION THEREOF AND USE THEREOF AS A VIRUCIDE

(71) Applicant: SERGE FERRARI SAS, Sanin Jean de Soudain (FR)

(72) Inventors: Jonathan ROJON, GLATTFELDEN (CH); Guilhem MERENNA, Zurich (CH)

(21) Appl. No.: 17/920,555

(22) PCT Filed: Apr. 23, 2021
(86) PCT No.: PCT/FR2021/050713

§ 371 Date: Oct. 21, 2022

(30) Foreign Application Priority Data
Apr. 24, 2020 (FR) 2004132

(51) Int. Cl. A01N 25/34; D06N 3/04; D06N 3/12; D06N 3/00; D06N 3/18; A01N 59/16; A01P 1/00

(52) U.S. Cl. CPC A01N 25/34; D06N 3/047; D06N 3/128; D06N 3/0063; D06N 3/183; A01N 59/16; A01P 1/00; D06N 2203/044; D06N 2203/066; D06N 2205/10; D06N 2209/16; D06N 2211/00; D06N 2201/02

(57) ABSTRACT

A composite membrane including at least one fabric, the membrane including a surface polymer layer, the surface polymer layer including silver and at least one polymer selected from the group formed by fluorinated polymers and silicones, and the membrane being such that silver is in the form of silver supported by a mineral matrix in powder form, the particle size of the matrix being strictly larger than 0.1 μm and strictly smaller than 20 μm. A method for manufacturing a membrane according to the invention. A use of a membrane according to the invention as a virucide.

### FIELD OF THE INVENTION

The invention relates to the field of composite membranes, more specifically fabrics impregnated or coated with antiadhesive hydrophobic polymers with low surface energy, typically usable as furniture coverings, for example seat coverings, protective tarpaulins or elements of modular structures.

More particularly, the invention relates to a new composite membrane structure which has both an antiviral action, good “cleanability” by commonly used solvents and antiseptics, typically isopropanol, good resistance to abrasion, good ability to be assembled, whether by adding filler bands or by a standard welding process, and good fire resistance. It could be used in the medical field or for sanitary reasons.

### BACKGROUND OF THE INVENTION

In the field of composite membranes, textiles coated or impregnated with a polymer material, preferably flame-retardant, are very commonly used. These coated or impregnated textiles have the advantage of being able to be easily assembled, to allow for a production adapted to the shape to be produced while preserving sealing of the membrane.

On the other hand, silver, for example in the form of particles of nanometric size (or nanoparticles), is used in the medical field mainly for its antibacterial effects. To date, silver nanoparticles are used in dressings where they have been coated by impregnation, or are dispersed in block-moulded polymers forming all or part of medical devices which are for example orthopaedic catheters or implants, quite particularly for limiting the formation of a pathogenic biofilm (as described for example in U.S. Pat. No. 9,625,065). Finally, textiles such as drapes, surgical masks or drapes may also contain silver nanoparticles, deposited by impregnation and present in the core of the material. However, these textile items are neither impermeable nor easy to assembly, for example by welding.

Hence, silver is commonly used for its bactericidal properties. Yet, it has been found quite recently that silver also has antiviral properties (Thesis No. 120, R. Chauvel, 2018, University C. Bernard Lyon 1—Faculty of Pharmacy and Institute of Pharmaceutical and Biological Sciences). The antiviral activity of silver is at the very beginning of investigations.

Indeed, bacteria and viruses are different entities, whether by size (viruses have on average a size about a thousand times smaller than that of bacteria which have a size of about 1 μm), by structure (the virus is considered as a biological entity and the bacterium is a living organism), or by genetic material (bacteria are prokaryotes provided with DNA and RNA; viruses have only one of these acids).

US 2016/184874 describes a fabric covered with a polymer layer, the use of this fabric, as well as a method for manufacture thereof. The polymer may be a fluorinated polymer or a polysiloxane (paragraph [0027]). According to one embodiment, the polymer layer contains silver nanoparticles. The process of preparing this fabric comprises a step of applying the polymer over the fabric (paragraph [0037]), for example by lamination or impregnation (paragraph [0039]). The antimicrobial effect of this tissue is attributed to silver nanoparticles whose size is preferably smaller than 100 nm (paragraphs [0042] to [0044]). Furthermore, the thickness of the polymer layer is from 100 to 500 μm, preferably from 150 to 450 μm, even more preferably from 200 to 400 μm (paragraph [0036)), which is high.

To date, there are no textiles coated or impregnated at the surface having the most common antiviral properties and resistance to detergents such as isopropanol, while preserving properties of a flexible composite membrane, namely an ability to be assembled, and resistance to abrasion and washing (cleanability), which could be used in the medical field or for sanitary reasons, for example for sanitary modular structures, tents, partition walls in hospitals, stretchers, or else mattress covers, or any other membrane that might be useful in the proximity of patients. Yet, there is a need to provide such a material, in order to limit the propagation of viruses and therefore an epidemic and even a pandemic.

Hence, the invention consists in providing a composite membrane having an antiviral activity, as well as a method for manufacturing such a membrane.

### SUMMARY OF THE INVENTION

According to a first aspect, the invention relates to a composite membrane comprising at least one fabric, said membrane comprising a surface polymer layer, said surface polymer layer comprising silver and at least one polymer selected from among fluorinated polymers and silicones, and said membrane being such that silver (4; 40) is in the form of silver supported by a mineral matrix in powder form, the particle size of the matrix being and strictly larger than 0.1 μm and strictly smaller than 20 μm.

Preferably, the polymer of the surface polymer layer consists of a fluorinated polymer or a silicone. According to the invention, the membrane may further comprise at least one intermediate polymer layer, for example a polyurethane layer or a polyvinyl chloride (PVC) layer or a silicone layer or a fluorinated polymer layer, the surface polymer layer being present at least partially over the intermediate polymer layer the furthest from the fabric, which preferably comprises the same polymer as the surface polymer layer. Hence, the surface polymer layer is the layer of the composite membrane in contact with the outside, the furthest from the fabric.

One or more intermediate polymer layer(s) may be deposited over each face of the membrane without one face necessarily being coated with the same number of intermediate polymer layers and the same nature and thickness of layer(s) as the corresponding other face.

However, it is particularly preferred that the polymer of the intermediate polymer layer in contact with the surface polymer layer and the polymer of the surface polymer layer be of the same family, preferably of the same nature. By “same family”, it should be understood that said polymers are both silicones or both fluorinated polymers. By “same nature”, it should be understood that said polymers are similar, for example both polyvinylydene chloride (PVDF). This allows for a better adhesion of the surface polymer layer to the intermediate polymer layer.

The composite membrane according to the invention is most often in the form of a strip with a suitable length, typically 50 m, and with a width (or web width) that could be up to 5 m. Thus, said composite membrane can be easily rolled or folded, and transported, which facilitates possible handling and logistics operations.

The silver content by weight in the polymer layer is comprised within the interval from 0.00001 to 10%, preferably from 0.0005 to 5%, more preferably from 0.001 to 3% (in % by weight).

Surprisingly, it has been discovered that silver is actively antiviral in its smallest more or less associated elementary size, that this associated elementary form is in the form of very small particles of colloidal type called nanoparticles (in which case the silver dispersion medium is water), or else dissolved in an aqueous medium, or else inserted into mineral matrices with a particle size in the range of micrometre (which allows it to be manipulated in powder form, which could be used in solvents). Surprisingly, the silver thus introduced into a surface polymer layer confers an antiviral activity on the composite membrane, while preserving its usual properties, i.e. resistance to cleaning by most antiseptics used in the sanitary and/or medical fields, in particular isopropanol, as well as resistance to abrasion. Thus, such a composite membrane has an advantageous service life. Another advantage of the invention is that the composite membrane can be easily assembled to another membrane, generally composite, whether by filler band or by welding, typically by heat-welding, without any loss of the antiviral properties. This allows for a customisable assembly of the composite membranes according to the invention according to the needs of the end user, which is particularly appreciable.

The main methods for assembling composite membranes are welds such as hot-air assemblies, high-frequency assemblies, thermal assemblies and ultrasonic assemblies; and assemblies with filler bands. All these assembly methods can be carried out on the composite membrane of the invention without the latter losing its antiviral activity.

Thus, the composite membrane according to the invention allows deactivating the viruses in the media used or inhabited by humans, through an antiviral function, i.e. which destroys viruses by surface contact, in the absence of any human cleaning intervention, in only a few minutes of contact.

By “fabric”, it should be understood according to the invention a textile material. The fabric forms the core or the reinforcement of the composite membrane.

Preferably, the fabric is selected from among wovens, nonwovens, grids, knits, and mixtures thereof, preferably from wovens and nonwovens.

According to an embodiment of the invention, the fabric is made of textile material and includes yarns or fibres based on a material selected from the group formed by glass, polyesters including aromatic polyesters (such as for example the commercial product Vectran® from the company Kuraray), polyamides including aromatic polyamides (such as for example the commercial product Kevlar® from the company Dupont), polyacrylates, viscoses, nylons, cottons, polyvinyl acetates, polyvinyl alcohols and mixtures thereof. Preferably, the fabric is a woven or non-woven made of polyester, typically high-tenacity polyester.

Surprisingly, according to the method of the invention, it has been possible to deposit a surface polymer layer over a possibly coated fabric, so as to produce a composite membrane, while the polymer of the surface polymer layer is an anti-adhesive hydrophobic polymer with low surface energy.

According to a first variant of the invention, the surface polymer layer has been deposited by impregnation, typically by padding. In this case, it is preferred that the composite membrane does not comprise an intermediate polymer layer, although the presence of at least one intermediate polymer layer is not excluded according to the invention. The surface polymer layer then has an average thickness comprised within the interval from 5 to 100 μm, preferably from 5 to 80 μm, even more preferably from 5 to 50 μm.

According to a second variant of the invention, the surface polymer layer has been deposited by coating, typically by deposition by scraper on a roll (“roll coat” or others) or by varnishing. In this case, it is preferred that the composite membrane comprises at least one intermediate polymer layer. The surface polymer layer then has an average thickness comprised within the interval from 0.5 to 20 μm, preferably from 1 to 12 μm, even more preferably from 2 to 10 μm. For example, the average thickness is between 4 and 8 μm. Furthermore, the thickness may vary from one point to the other of the surface polymer layer typically by + or −3 μm.

Regardless of the variant, the appearance of the external surface of the surface polymer layer follows the appearance of the intermediate polymer layer with which it is in contact or else of the fabric with which it is in contact, and is therefore not completely regular.

The polymeric intermediate layer may also contain at least one additive such as a pigment, for example a nickel titanate, or else a titanium dioxide; at least one flame-retardant filler such as antimony trioxide, alumina trihydrate, zinc borate or calcium carbonate; a fungicide and/or any other additive known to the person skilled in the art.

According to the invention, the silver is supported by a mineral matrix which is in powder form dispersed or not in a liquid medium.

Silver which has the antiviral function is present in the mineral (or inorganic) matrix. The matrix is in powder form comprising an atomic network within which silver atoms are inserted. In other words, the silver is gathered in the matrix, preferably in the form of silver particles. The matrix serves as a silver reservoir which will be available at the surface of the composite membrane to destroy the viruses. The silver may also be at the surface of the grains of the mineral matrix.

Several mineral matrices that could serve as a silver support are commercially available. For example, they are as follows.

Phosphate glasses containing oxides of phosphorus, silicon, calcium, magnesium and possibly other elements; these products are sold in particular by the company Ishizuka under the name lonpure® or by the company Sanitized under the name Sanitized® BCA 2141.

Zeolites, for example of formula Ag₂O/Al₂O₃/SiO₂/H₂O, sold in particular by the company Sinanen under the name Zeomic®.

Zirconium phosphate, mixed or not with zinc oxides, sold in particular by the company Milliken under the references AlphaSan®RC7000 or AlphaSan®RC5000.

Silver chloride-coated titanium dioxides, sold in particular by the company Clariant under the name JMAC, which could then be used in preparations such as those from the company HeiQ, viroblock NPJ03.

According to the invention, the matrix should have a particle size compatible with the thickness of the surface polymer layer, i.e. generally a particle size strictly smaller than 20 μm, preferably strictly smaller than 5 μm. In all cases, this size is generally larger than or equal to 0.1 μm. The particle size of the matrix is often comprised within the interval from 0.1 to 20 μm, preferably from 0.1 to 5 μm.

By “size”, it should be understood according to the invention the largest dimension of the particle. According to a preferred embodiment, the d98 of the particles of the silver-containing matrix is smaller than 18 μm, preferably smaller than 10 μm, and the d50 of the silver-containing matrix is smaller than or equal to 6 μm, preferably smaller than or equal to 3 μm. By d98, it should be understood the maximum size of 98% of the particles (in number). By d50, it should be understood the maximum size of 50% of the particles (by number).

In general, the silver content in the matrix is comprised between 0.01 and 10%, preferably between 0.1 and 5%, preferably between 1 and 3%, by weight % relative to the matrix. According to this embodiment of the invention, the silver content by weight in the surface polymer layer is comprised within the interval from 0.01 to 5%, preferably from 0.05 to 3%, even more preferably from 0.05 to 2%, by weight. This content is expressed relative to the silver element and is calculated once the polymer layer is dried.

In general, the polymer is selected from the group formed by silicones and fluorinated polymers. These are polymers with low surface energy and therefore hydrophobic.

Advantageously, the polymeric surfaces of the silicone or fluorinated type are easily cleanable thanks to a low surface tension. They also exhibit low innocuousness and reactivity with the skin (ISO 10993-5 non-cytotoxic and 10993-10 non-irritable).

Furthermore, in contrast with plasticised PVC (polyvinyl chloride) type polymeric surfaces that degrade when using isopropanol type solvents, silicones and PVDF type fluorinated polymers are advantageously biocompatible and easily cleanable because they are resistant to disinfectants including isopropanol which is widely used, for example, in hydroalcoholic gels. Thus, the composite membranes according to the invention find multiple applications in the medical field since they also have the antiviral function.

Preferably, the silicone is a polysiloxane. Advantageously, the silicone is selected from the group comprising polydimethylsiloxanes, polyphenylsiloxanes, oligosiloxanes, polyaminosiloxanes, polyvinylsiolxanes and copolymers thereof.

By “copolymer”, it should be understood according to the invention a polymer resulting from the copolymerisation of at least two types of monomer, chemically different. By “homopolymer”, it should be understood according to the invention a polymer derived from the polymerisation of a single type of monomer. By “(co)polymer”, it should be understood according to the invention a polymer or copolymer.

Silicone polymers that could be used in the solvent phase are known in the market, such as the product Elastosil® RD 6620 F further comprising a crosslinking agent and a catalyst, from the company Wacker.

In general, the fluorinated polymer is polyvinylidene fluoride (or PVDF), or a polymer based on tetrafluoroethylene, hexafluoropropylene, and vinylidene fluoride, also known as THV, PTFE, fluorinated ethylene propylene (FEP), perfluoroalkoxy (PFA) and, in general, numerous fluorinated polymers, as well as fluorinated acrylics and methacrylics, considered alone or as a mixture. Preferably, the fluorinated polymer is PVDF.

According to a preferred embodiment, the surface polymer layer may further comprise at least one additive selected from among UV stabilisers, mattness agents, heat stabilisers, flame-retardant compounds and pigments.

Preferably, the UV stabiliser is present when the composite membrane is intended to be used outdoors. Preferably, the UV stabiliser is selected from among benzotriazoles and triazines, even more preferably selected from among triazines, for example the commercial product Tinuvin® 400 (hydroxytriazine) from the company BASF.

In general, the mattness agent is organic or inorganic, preferably selected from polymeric additives of the polymethyl urea type or inorganic of the fumed silica type. It usually allows conferring on the surface polymer layer the desired finish appearance (bright, satin, matt, etc.).

In general, the flame-retardant compound is selected from the group comprising aluminium trihydrate, magnesium hydroxide, silicas, zeolites, antimony trioxide 15 (Sb203), calcium carbonate (CaCO3), as well as inorganic pigments.

The surface polymer layer may be transparent or coloured, typically by adding at least one pigment in the polymer composition. For example, the pigment is selected from the group formed by titanium dioxide (white), carbon black, phthalocyanine, or mixtures thereof.

In a particularly preferred manner according to the invention, the surface polymer layer does not comprise a sulphur compound. This advantageously allows preserving the antiviral property of the membrane, related to the silver particles present in the surface polymer layer.

According to a second aspect, the invention relates to a method for manufacturing a composite membrane according to the invention, comprising the following steps:

(a) providing a coated membrane comprising at least one fabric possibly coated over at least one face with at least one polymeric intermediate layer;

(b) providing a polymer composition comprising at least one solvent, at least one polymer, and silver;

(c) depositing over at least one face possibly coated of step (a) a layer of the polymer composition of step (b), over a given thickness; and

(d) drying the surface polymer layer of the step, leading to the obtainment of the composite membrane.

In general, the solvent is selected from among solvents capable of solubilising the polymer, depending on the nature of the polymer. Preferably, the solvent is selected from the group formed by water, ketones such as methyl ethyl ketone (or MEC), acetone, diethyl ketone, methyl isobutyl ketone, diisobutyl ketone, gamma butyrolactone or cyclohexanone; alcohols (non cyclic) such as ethyl alcohol, isopropyl alcohol, N-propyl alcohol, benzyl alcohol or furfuryl alcohol; cyclic alcohols such as cyclohexanol; acetates such as ethyl acetate or butyl acetate; ketone alcohols such as diacetone alcohol (DAA); cyclic ethers such as tetrahydrofuran (THF), propylene glycol monoethyl ether acetate, methoxypropyl acetate; aromatic solvents such as toluene or xylene; hydrocarbon solvents such as heptane or cyclohexane; N,N-dimethylformamide (DMF); and mixtures thereof.

According to a first embodiment, the solvent is an aqueous medium. This is referred to as the aqueous route.

By “aqueous medium”, it should be understood according to the invention a liquid phase generally comprising several chemical species, wherein water is the predominant constituent and dissolved chemical species which are minority.

According to a second embodiment, the solvent is selected from the group formed by ketones such as methyl ethyl ketone (or MEK), acetone, diethyl ketone, methyl isobutyl ketone, diisobutyl ketone, gamma butyrolactone or cyclohexanone; alcohols (non cyclic) such as ethyl alcohol, isopropyl alcohol, N-propyl alcohol, benzyl alcohol or furfuryl alcohol; cyclic alcohols such as cyclohexanol; acetates such as ethyl acetate or butyl acetate; ketone alcohols such as diacetone alcohol (DAA); cyclic ethers such as tetrahydrofuran (THF), propylene glycol monoethyl ether acetate, methoxypropyl acetate; aromatic solvents such as toluene or xylene; hydrocarbon solvents such as heptane or cyclohexane; N,N-dimethylformamide (DMF); and mixtures thereof. This is referred to as the solvent route.

According to a first variant, regardless of the embodiment (aqueous route or solvent route), step (c) is performed by impregnation, the average thickness of the polymer layer being comprised within the interval from 5 to 100 μm, preferably from 5 to 80 μm, more preferably from 5 to 50 μm.

In this case, the impregnation uses polymer compositions in the aqueous route and in the solvent route substantially similar to those described hereinafter for coating. The padding technique is very widespread. In general, it consists in making the surface of the fabric or of the coated fabric, preferably of the fabric, pass through a bath containing the fluid polymer impregnation composition, then in expressing the excess absorbed fluid by applying a pressure between two pressing rollers, or draining rollers, and finally in passing through a drying oven. Indeed, when the surface of the fabric is treated with a polymer composition comprising an organic solvent (or diluent), it is desirable to subsequently eliminate the solvent, for example to subject this membrane item to a heat treatment in order to remove the solvent generally in gaseous form.

According to a second variant, regardless of the embodiment (aqueous route or solvent route), step (c) is performed by coating, the average thickness of the polymer layer being comprised within the interval from 0.5 to 20 μm, preferably from 1 to 12 μm, even more preferably from 2 to 10 μm.

In this case, there has generally been deposition of an intermediate polymer layer, by coating, before deposition of the surface polymer layer; the polymer composition is then a varnish and the polymer layer is then a varnish film.

By “varnish”, it should be understood according to the invention a liquid, coloured or not, which has an ability to form a film, after application over a substrate and drying. The polymer is one of the essential components of the varnish.

In the case of the aqueous route, in a first case silver is present in the form of silver particles supported by a mineral matrix and possibly added with other elements such as liposome vesicles for the product viroblock NPJ03 from the company HeiQ.

In the case of the aqueous route, a silicone dispersion may be the commercial products TCS 7110 A® and TCS 7110 B® from the company Elkem, often used mixed together. An aqueous PVDF dispersion, typically mixed with an acrylic polymer that may contain different acrylic ratios, may for example be the commercial products Kynar Aquatec® FMA-12 (50 PVDF-50 acrylic ratio) or Kynar Aquatec® CRX (70 PVDF-30 acrylic ratio) from the company ARKEMA.

In the case of the solvent route, the polymer composition of step (b) may be a commercial product to which the matrix is added, generally by mixing. It is also possible to manufacture it as is known to the person skilled in the art, typically by mixing the constituents of the polymer composition. When it comprises, as explained hereinabove, an additive, this additive has also been mixed within the polymer composition as is known to the person skilled in the art.

Advantageously, the method of the invention allows applying over a coated membrane at least a deposit of a few micrometres of a varnish film in which silver particles supported by a matrix in powder form have been dispersed, and making it adhere, while preserving the properties of said membrane. Advantageously, the invention allows making a very thin and very resistant layer of varnish, as will be demonstrated in the examples.

Thus, advantageously, the varnish film according to the invention adheres to the coated membrane and is resistant to abrasion, to water, to soiling, and to a large number of detergents, the most used of which is isopropanol, alone or as a mixture. Where necessary, the polymer composition according to the invention may be formulated to have a desired particular appearance (mattness, gloss, . . . ) or a particular resistance (such as UV resistance in the case of use of the membrane according to the invention outdoors), as explained hereinbefore.

According to a third aspect, the invention relates to a use of a membrane according to the invention or manufactured according to the method according to the invention, as a virucide, generally in the technical textile industry.

### BRIEF DESCRIPTION OF THE FIGURES

The way in which the invention is implemented, as well as the advantages arising therefrom, will come out from the description of the following embodiments, with reference to the appended FIGS. 1 to 4, wherein:

FIG. 1 is a schematic sectional view of a first embodiment of the membrane of the invention.

FIG. 2 is an enlargement of FIG. 1.

FIG. 3 is a schematic sectional view of a second embodiment of the membrane of the invention.

FIG. 4 is an enlargement of FIG. 3.

FIG. 5 is a photograph captured by transmission electron microscopy (or TEM) of powder particles of an embodiment according to the invention.

The micrometric dimension of such particles could be seen.

Of course, the dimensions and proportions of the elements illustrated in FIGS. 1 to 4 have been exaggerated relative to reality, and have been given only for the purpose of facilitating understanding of the invention.

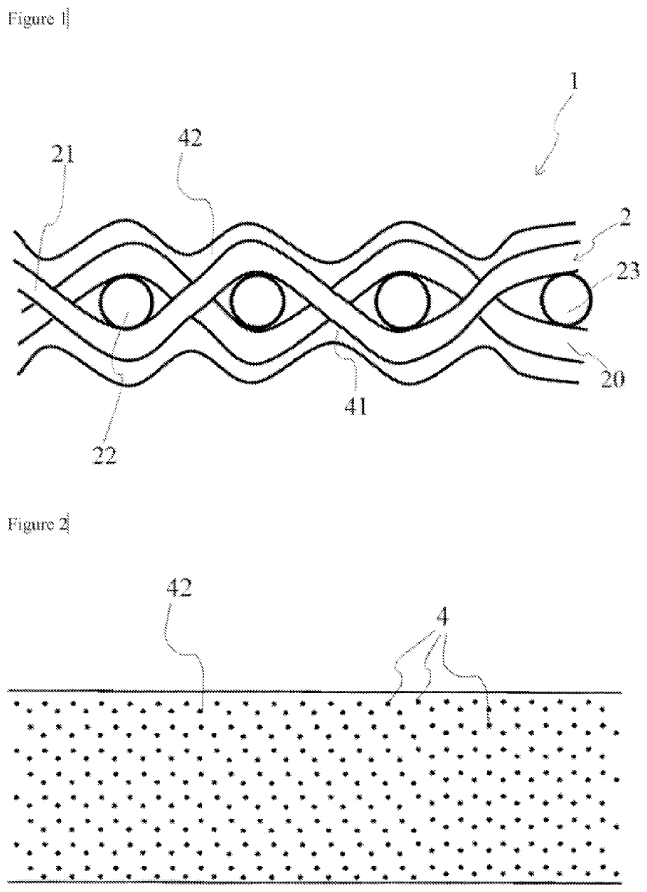

The composite membrane 1 of FIG. 1 comprises a textile core or reinforcement 2 consisting of a weave made of high tenacity polyester yarns, formed of warp yarns 22 intersecting with weft yarns 21 and 23. According to the invention, the woven core 2 has been coated over both of its faces with two layers of polymer such as silicone respectively 41 and 42 on each face, the layer 42 being enlarged in FIG. 2. The layer 42 comprises a matrix in powder form 4 comprising silver particles, said powder being dispersed within the layer 42.

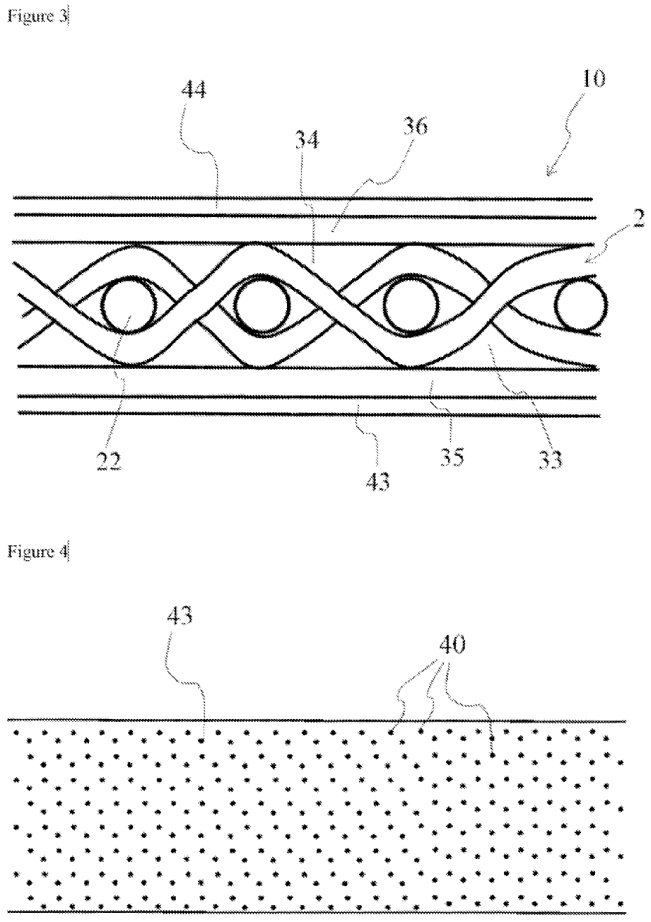

The composite membrane 10 of FIG. 3 comprising the same textile core or reinforcement 2. Afterwards, the woven core 2 has been on its two faces with two successive layers of polymer such as silicone respectively 34 then 36 over one face and 33 then 35 over the other face. According to the invention, two layers respectively 44 and 43 have been deposited over each coated face, the layer 43 being enlarged in FIG. 4. The layer 43 comprises a matrix in powder form 40 comprising silver particles, said powder being dispersed within the layer 43.

### EXAMPLES

Different tests have been carried out on the same composite membrane which is a high-tenacity polyester fabric which is coated with a surface polymer layer (either PVDF or silicone), for each of the three varnishes of the examples. All tests have also been performed on a comparative composite membrane, i.e. a membrane containing no silver.

### Example No. 1

The varnish, made by simple mixing, had the following composition (in parts by weight): Aqueous silicone dispersion from the company Elkem TCS 7110A® (91%) and TCS 7110B® (9%): 100

Silver: product Viroblock®NPJ03 from the company HEIQ: 20 (such that the average size of the reaction mass agglomerates (titanium dioxide-silver chloride) is about 1.56±71 μm).

### Example No. 2

The varnish, made by simple mixing, comprised an aqueous dispersion of a PVDF-acrylic copolymer with the trade name Kynar Aquatec® FMA 12 from the company ARKEMA and of the silver product Viroblock®NPJ03 from the company HEIQ in the following proportions (parts by weight):

Aquatec®FMA12: 100

Silver: product Viroblock®NPJ03 from the company HEIQ: 20

### Example No. 3

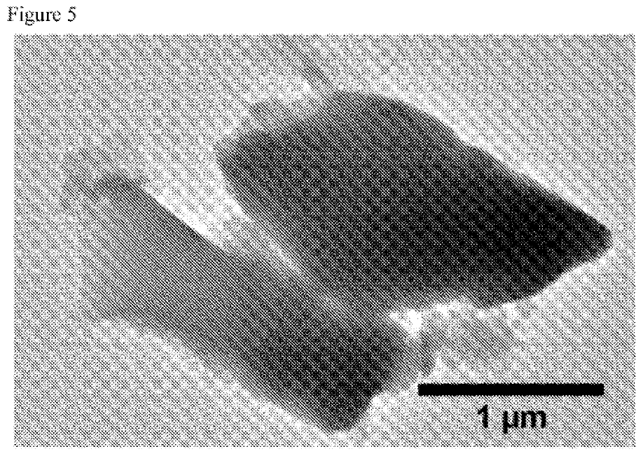

The used silver was in powder form (phosphate glass matrix), a commercial product Sanitized® BCA 2141 from the company Sanitized, photographed in TEM in FIG. 5.

The varnish comprised a solvent-based silicone varnish, Elastosil®RD 6620 F, from the company Wacker, formulated with the crosslinking compounds and catalysts recommended by the manufacturer; to which 3% of BCA 21-41 have been added.

Test Demonstrating the Weldability and Manufacture of the Composite Membranes According to the Invention.

Tests have been carried out on a high-frequency bench and/or industrial heating press, to verify that the hold of the polymers on the fabric has been sufficient.

The silicone composite membranes have been assembled using a HVE (hot-vulcanisable elastomer) type filler band. The PVDF composite membranes have been assembled either at hot temperature (heating press) or by high frequency depending on the grade. After this high-frequency or thermal assembly, with or without a filler band, the force necessary to open the weld according to the protocol described in the standard EN 15619 Appendix C.

The obtained value should to be equal to or greater than the value 20N over a width of 5 cm in order to guarantee enough strength of the assemblies and sealing.

Test of Activity Against Viruses

Preliminary tests that allow verifying the feasibility of the test:

cell cytotoxicity control

membrane residual activity control.

Controls carried out during the tests:

cell cytotoxicity control

membrane residual activity control

stainless steel disc 304 positive control

The virological analyses are carried out by determining the infectious titres on MRCS cells (ATCC CCL-171) in limit dilution. The readings of the cytopathogenic effects (CPEs) are collected after 6 days of incubation at 37° and 5% CO2.

The test has been performed in comparison with a reference coated membrane, i.e. a membrane containing no silver.

The human coronavirus HCoV-229E which is part of the family of enveloped alpha coronaviruses has been used in the test.

The time of contact between the membrane (comparative or according to the invention) and the solution containing the virus is 60 min.

Two environmental conditions have been tested:

Standardised cleanliness condition in the medical field 0.3 g/l BSA;

Complex interference condition: saliva and respiratory mucus.

The solution comprising the virus has been deposited in an amount of 50-100 μL and the deposited amount of virus has been 105 TCID50 (standing for 50% Tissue Culture Infectious Dose: titre required to cause infection in 50% of the inoculated cell cultures).

In comparison with the comparative membrane (without silver), the results have been, for each composite membrane according to the invention, a reduction of more than 90% of the viral load at 60 min of contact, whether for the virus alone or for the virus with mucus and saliva.

Compliance has been established for a value strictly higher than 90% after 1 h of contact with no mucus or saliva. Consequently, the tests have demonstrated the antiviral function of the composite membranes according to the invention.

Test for Stability and Resistance to Isopropanol by the Loss of Weight

Objectives: Replicate in the laboratory a cleaning of the materials with isopropanol. Assessment of the mass losses of different products in isopropanol (CAS No. 67-63-0)

Description of the test:

Cut a sample with a size 3*3 cm: 9 cm², weigh it using a precision balance, then place it in the glass flask and immerse it in about 50 mL of isopropanol. Close the vial.

Wait for the time required for the measurement: between 15 minutes and 2 hours

After the desired time, place the sample in the oven at 60° C. for 5 minutes twice (5 minutes per face to evaporate the isopropanol).

Weigh the sample again.

The sample has been placed so as to be totally immersed in isopropanol.

Calculation of mass losses:

$$\% mass loss = \frac{M final - M initial}{M initial}$$

Thus, the obtained mass loss values allow plotting the mass loss of each tested material over time. This test has allowed assessing the resistance of the materials to cleaning with disinfectants including isopropanol. The result has been considered to be “good” if the weight loss did not exceed 5% by weight of the composite membrane and if the appearance and the flexibility of the membrane have not been modified.

Tests of Cleanability of the Composite Membrane According to the Invention

The betadine and eosin stain resistance of the composite membranes according to the invention has been tested according to the following procedure:

Measure the initial colour of the fabric and record it

Take a non-woven cloth as used in hospital environments

Impregnate with betadine or eosin using the cloth and spread over the fabric. Let “dry” for 10 minutes.

Wipe with clean dry towelette

Measure the delta E (cmc) which quantifies the colour evolution on the 2 types of stains

Clean with isopropanol.

Re-measure the delta E (cmc) after cleaning

if delta E (cmc)<2 excellent cleaning

if delta E (cmc)<5 good cleaning

if delta E (cmc) <7 average cleaning

if delta E (cmc) >7 poor cleaning

The composite membranes according to the invention have allowed obtaining results which qualify cleaning as “good”, whether for betadine or for eosin

Results of the Rests

| | | Resistance | | Strength | |
|---|---|---|---|---|---|
| | | to | | of the | Hold |
| | | isopropanol | Clean- | assemblies | of the |
| | Anti- | (weight loss | ability | N/5 cm | layer |
| | viral | lower than | of the | (higher than | after |
| | activity | 5% after 2 h) | stains | 20N/5 cm) | cleaning |
| Silicone | NOK | OK | Good | OK | Good |
| comparative | | | | 100 daN/ | |
| membrane | | | | 5 cm | |
| Silicone | >90% | OK | Good | OK | Good |
| membrane | | | | 100 daN/ | |
| example 1 | | | | 5 cm | |
| according to | | | | | |
| the invention | | | | | |
| PVDF | NOK | OK | Good | OK | Good |
| comparative | | | | 40 daN/ | |
| membrane | | | | 5 cm | |
| PVDF | >90% | OK | Good | OK | Good |
| membrane | | | | 38 daN/ | |
| example 2 | | | | 5 cm | |
| according to | | | | | |
| the invention | | | | | |
| Silicone | NOK | OK | Good | OK | Good |
| comparative | | | | 150 daN/ | |
| membrane | | | | 5 cm | |
| Silicone | >90% | OK | Good | OK | Good |
| membrane | | | | 150 daN/ | |
| example 3 | | | | 5 cm | |
| according to | | | | | |
| the invention | | | | | |

Where “OK” means that the test is deemed to be conclusive: the coated and varnished membrane according to the invention is compliant: cleanness has been validated.

In conclusion, it has been demonstrated that the composite membranes according to the invention have a resistance to cleaning with isopropanol, as well as an antiviral action, while preserving the desired properties of the corresponding comparative composite membranes.

1. A composite membrane, said membrane comprising at least one fabric, said membrane comprising a surface polymer layer, said surface polymer layer comprising silver and at least one polymer selected from the group formed by fluoropolymers and silicones, and said membrane being such that the silver is in the form of silver supported by a mineral matrix in powder form, a particle size of the matrix being strictly larger than 0.1 μm and strictly smaller than 20 μm.

2. The composite membrane according to claim 1, such that it comprises at least one intermediate polymer layer the polymer of the intermediate polymer layer in contact with the surface polymer layer and the the polymer of the surface polymer layer being both silicones, or both fluorinated polymers.

3. The composite membrane according to claim 2, such that the surface polymer layer has an average thickness comprised within an interval from 0.5 to 20 μm.

4. The composite membrane according to claim 1, such that the surface polymer layer has an average thickness comprised within an interval from 5 to 100 μm.

5. The composite membrane according to claim 1, such that a silver content by weight in the polymer layer is comprised within an interval from 0.00001 to 10%.

6. The composite membrane according to claim 1, such that the silver is in the form of silver supported by a mineral matrix in powder form, the particle size of the matrix being strictly larger than 0.1 μm and strictly smaller than 5 μm.

7. The composite membrane according to claim 1, such that the fabric is selected from wovens, nonwovens, grids, knits, and mixtures thereof.

8. The composite membrane according to claim 1, such that the fabric is made of textile material and includes yarns or fibres based on a material selected from the group formed by glass, polyesters, polyamides, polyacrylates, viscoses, nylons, cottons, polyvinyl acetates, polyvinyl alcohols and mixtures thereof.

9. The composite membrane according to claim 1, such that the polymer layer further comprises at least one additive selected from among UV stabilisers, matting agents, heat stabilisers, flame-retardant compounds and pigments.

10. A method for manufacturing the composite membrane according to claim 1, comprising the following steps:
(a) providing a coated membrane comprising the at least one fabric coated over at least one face with at least one polymeric intermediate layer;
(b) providing a polymer composition comprising at least one solvent, the at least one polymer, and the silver;
(c) depositing over the at least one face coated during step (a) of a surface layer of the polymer composition of step (b), over a given thickness; and
(d) drying the surface polymer layer of step (c), leading to an obtaining of the composite membrane.

11. The method according to claim 10, such that the solvent is selected from the group formed by water, ketones, alcohols, cyclic alcohols, acetates, ketone alcohols, cyclic ethers, aromatic solvents, hydrocarbon solvents, and mixtures thereof.

12. The method according to claim 10, such that step (c) is performed by impregnation, an average thickness of the polymer layer being comprised within an interval from 5 to 100 μm.

13. The method according to claim 10, such that step (c) is performed by coating, an average thickness of the polymer layer being comprised within an interval from 0.5 to 20 μm.

14. The composite membrane according to claim 1, said membrane being configured for use as a virucide.

15. The method according to claim 10, such that step (c) is performed by impregnation, an average thickness of the polymer layer being comprised within an interval from 5 to 50 μm.

16. The method according to claim 10, such that step (c) is performed by coating, an average thickness of the polymer layer being comprised within an interval from 2 to 10 μm.

17. The composite membrane according to claim 2, such that the surface polymer layer has an average thickness comprised within an interval from 2 to 10 μm.

18. The composite membrane according to claim 1, such that the surface polymer layer has an average thickness comprised within an interval from 5 to 50 μm.

19. The composite membrane according to claim 1, such that a silver content by weight in the polymer layer is comprised within an interval from 0.001 to 3%.
